(19) United States
(12) Patent Application Publication
(10) Pub. No.: US 2026/0367554 A1
(43) Pub. Date: Nov. 19, 2026

(54) FIXING APPARATUS AND IMAGE FORMING APPARATUS

(71) Applicant: CANON KABUSHIKI KAISHA, Tokyo (JP)

(72) Inventor: TAKAAKI TSURUYA, Shizuoka (JP)

(21) Appl. No.: 19/661,982

(22) Filed: Apr. 29, 2026

(30) Foreign Application Priority Data
May 16, 2025 (JP) 2025-082532

(51) Int. Cl. G03G 15/20; G03G 15/00

(52) U.S. Cl. CPC G03G 15/2053; G03G 15/2039; G03G 15/2064; G03G 15/5004; G03G 2215/2035

(57) ABSTRACT

A fixing apparatus includes a film including a heat generating layer, an inner layer, and an outer layer, a magnetic member, a coil, a power supply, a control portion configured to control a frequency of the alternating current output from the power supply, a nip forming member, and a pressing member, and configured to form a nip portion between the pressing member and the nip forming member. The control portion is configured to execute (i) a first mode in which the film is rotated while conveying a recording material to the nip portion with the frequency set to a first frequency, and (ii) a second mode in which the film is rotated without conveying the recording material to the nip portion with the frequency set to a second frequency lower than the first frequency.

### BACKGROUND

### Field of the Technology

The present disclosure relates to a fixing apparatus that fixes an image to a recording material, and an image forming apparatus that includes the fixing apparatus.

### Description of the Related Art

Japanese Patent Application Publication No. 2024-094076 discloses a fixing apparatus that fixes a toner image transferred to a recording material, to the recording material by heating and pressing the toner image. The fixing apparatus includes a fixing film including a heat generating layer, and a coil inserted in the internal space of the fixing film. In this configuration, alternating current flows in the coil, so that an alternating magnetic field is produced and circumferential current flows in the heat generating layer due to the principle of electromagnetic induction. In this manner, the Joule heat is produced in the heat generating layer, so that the fixing film is heated.

However, if the fixing film is used over a long period of time, unevenness in the electrical resistance value is produced in the longitudinal direction of the fixing film, possibly causing an image defect such as unevenness in the fixing performance.

One of problems to be solved by the embodiment disclosed in the present specification and drawings is to provide a fixing apparatus that can reduce the image defect. However, the problems to be solved by the embodiment disclosed in the present specification and drawings are not limited to the above-described problem. A problem that corresponds to an effect of each configuration described in the below-described embodiment may be regarded as another problem.

### SUMMARY

According to one aspect of the present disclosure, a fixing apparatus configured to fix a toner image borne on a recording material to the recording material includes a film having a tubular shape and extending in a longitudinal direction, the film including a heat generating layer, an inner layer formed on an inner circumference side of the heat generating layer, and an outer layer formed on an outer circumference side of the heat generating layer, a magnetic member inserted in an internal space of the film and extending in the longitudinal direction, a coil helically wound around the magnetic member along the longitudinal direction, a power supply configured to generate an alternating magnetic field by supplying alternating current to the coil and to cause the heat generating layer to generate heat by induced current, a control portion configured to control a frequency of the alternating current output from the power supply, a nip forming member configured to slide on an inner surface of the film, and a pressing member configured to abut against an outer surface of the film, disposed such that the film is nipped by the pressing member and the nip forming member, and configured to form a nip portion between the pressing member and the nip forming member. The control portion is configured to execute (i) a first mode in which the film is rotated while conveying a recording material to the nip portion with the frequency set to a first frequency, and (ii) a second mode in which the film is rotated without conveying the recording material to the nip portion with the frequency set to a second frequency lower than the first frequency.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image forming apparatus of an embodiment.

FIG. 2 is a cross-sectional view of a fixing apparatus of the embodiment.

FIG. 3 is a perspective view of the fixing apparatus of the embodiment.

FIG. 4 is a perspective view of an exciting coil and a magnetic core of the embodiment.

FIG. 5 is a diagram for illustrating the principle of heating of the fixing apparatus of the embodiment.

FIG. 6 is a schematic diagram for illustrating the difference in magnetic flux between an end portion and a center portion of a heat generating layer of the embodiment.

FIG. 7A is a photograph of the fixing film of the embodiment, captured with an infrared camera.

FIG. 7B is a graph in which the temperature of a portion of the fixing film indicated by a section line illustrated in FIG. 7A is plotted.

FIG. 8A is a photograph of the fixing film captured with an infrared camera in a case where the driving frequency is decreased to 45 kHz.

FIG. 8B is a graph in which the temperature of a portion of the fixing film indicated by a section line illustrated in FIG. 8A is plotted.

FIG. 9 is a diagram illustrating a shape of a sliding member of the embodiment.

FIG. 10 is a diagram for illustrating a neutral axis of a film-like member.

FIG. 11 is a graph indicating a temperature dependence of Young's modulus of each layer of the fixing film of the embodiment.

FIG. 12 is a graph indicating the increase of resistance of the heat generating layer in a case where the fixing film is caused to run idle under different temperature conditions.

### DESCRIPTION OF THE EMBODIMENTS

Hereinafter, an embodiment of the present disclosure will be described with reference to drawings.

In the present disclosure, the image forming apparatus is not limited to a single-function printer that has the printing function alone. That is, examples of the image forming apparatus widely include apparatuses that form images on recording materials. For example, the image forming apparatus may be a copying machine that has a copy function, a multi-function printer that has multiple functions, or a large-sized commercial printer.

In addition, in the present disclosure, examples of the fixing apparatus widely include apparatuses (image heating apparatuses) that fix an image formed on a recording material by using the electrophotographic process or the like, to the recording material by heating the image. The fixing apparatus may be an apparatus disposed for giving the gloss to an image that has already been fixed (primary-fixed) to a recording material, by heating the image again.

### 1. Image Forming Apparatus

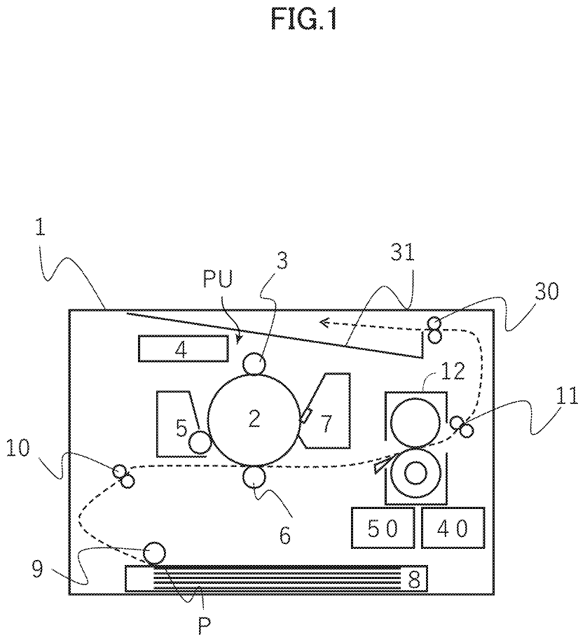

The overall configuration of an image forming apparatus of an embodiment of the present disclosure will be described with reference to FIG. 1. FIG. 1 is a cross-sectional view illustrating a schematic configuration of a laser-beam printer (hereinafter referred to as a printer 1) that serves as an example of the image forming apparatus. The printer 1 performs an image forming operation that forms an image on a recording material P, based on image information sent from an external apparatus such as a personal computer. The recording material (recording medium) P may be any one of a variety of sheets with different sizes and materials. For example, the recording material P may be a paper sheet, such as a regular paper sheet or a thick paper sheet, a sheet material, such as a coated paper sheet, on which certain surface treatment has been performed, a specially-shaped sheet material, such as an envelope or an index paper sheet, a plastic film, or a cloth sheet.

The printer 1 includes a process unit PU that serves an image forming portion that forms an image on the recording material P by using the electrophotographic process, and a fixing apparatus 12 that fixes the image to the recording material P.

The process unit PU includes a photosensitive drum 2 that serves as an image bearing member, a charging roller 3 that serves as a charging portion, a laser scanner unit 4 that serves as an exposing portion, and a developing apparatus 5 that serves as a developing portion. In addition, the process unit PU includes a transfer roller 6 that serves as a transfer portion, and a cleaning blade 7 that serves as a cleaning portion. The photosensitive drum 2 is a cylindrically-formed photosensitive member. The developing apparatus 5 includes a container that contains toner that serves as developer, and a developing roller that bears toner and supplies the toner to the photosensitive drum 2.

In the image forming operation, the photosensitive drum 2 is driven and rotated, and the charging roller 3 uniformly charges the surface of the photosensitive drum 2. The laser scanner unit 4 forms an electrostatic latent image, which corresponds to image information, on the surface of the photosensitive drum 2 by exposing the surface of the photosensitive drum 2, by emitting a laser beam to the photosensitive drum 2 in accordance with a digital image signal generated, based on the image information, by the image processing portion of the printer 1. The developing apparatus 5 supplies the toner to the photosensitive drum 2, and develops the electrostatic latent image into a toner image.

In parallel with the formation of the toner image, the recording material P is conveyed. In a lower portion of the printer 1, a cassette 8 is accommodated so as to be able to be drawn out from the printer 1. In the cassette 8, the recording material P is stored, stacked on the cassette 8. The recording material P stored in the cassette 8 is fed, one by one, by a feeding roller 9 that serves as a feeding portion, and is conveyed to a transfer portion by a conveyance roller pair 10.

The transfer roller 6 transfers the toner image from the photosensitive drum 2 to the recording material P in a transfer portion between the photosensitive drum 2 and the transfer roller 6. Foreign substance, such as transfer residual toner, left on the photosensitive drum 2 without having been transferred to the recording material P is removed by the cleaning blade 7.

The recording material P that has passed through the transfer portion is sent to the fixing apparatus 12. The fixing apparatus 12 is supplied with electric power from a power supply 40. The output power of the power supply 40 is controlled by a control portion 50. While conveying the recording material P, the fixing apparatus 12 fixes the image formed on the recording material P, to the recording material P by heating and pressing the image. The detailed description of the fixing apparatus 12 will be made later. The recording material P that has passed through the fixing apparatus 12 is conveyed to a discharging roller pair 30 via a conveyance roller pair 11, and is discharged to a discharging tray 31 by the discharging roller pair 30.

In the present embodiment, the description has been made for the direct-transfer image forming portion. However, an intermediate-transfer image forming portion may be used. In this case, a toner image is primary-transferred from an image bearing member to an intermediate transfer member, such as an intermediate transfer belt, and then the toner image is secondary-transferred from the intermediate transfer member to a recording material. In addition, the image forming portion may form a color image by using toners with a plurality of colors.

### 2. Fixing Apparatus

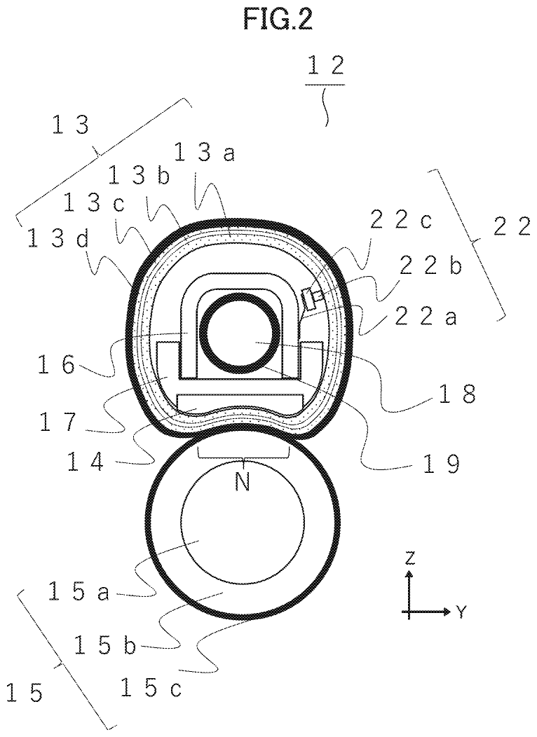

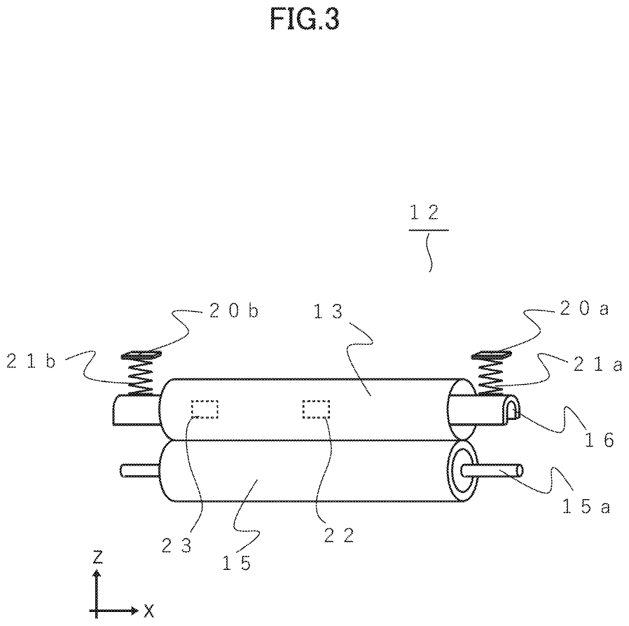

Next, the fixing apparatus 12 will be described. The fixing apparatus 12 of the present embodiment is an induction-heating fixing apparatus. FIG. 2 is a cross-sectional view of the fixing apparatus 12, and FIG. 3 is a perspective view of the fixing apparatus 12.

As illustrated in FIGS. 2 and 3, the fixing apparatus 12 includes a fixing film 13, a sliding member 14, a pressing roller 15, a stay 16, a holder 17, a magnetic core 18 serving as a magnetic member, an exciting coil 19 serving as a coil, and temperature sensors 22 and 23.

The fixing film 13 is a tubular (endless) film having flexibility. The fixing film 13 is an example of a heating member (rotary heat-generating member) that heats an image formed on a recording material. The sliding member 14 is an example of a nip forming member which is in contact with the inner surface (inside surface) of the fixing film 13, and on which the fixing film 13 slides. The pressing roller 15 is an example of a pressing member which is abutted against the sliding member 14 via the fixing film 13; and between the pressing member and the sliding member 14, a nip portion N (i.e., a fixing nip) is formed. That is, the pressing roller 15 is in contact with the outside surface (outer circumferential surface) of the fixing film 13.

The exciting coil 19 and the magnetic core 18 are an example of a heat generating mechanism that causes a heat generating layer 13b of the fixing film 13 to generate heat, by flowing current in the heat generating layer 13b. The exciting coil 19 and the magnetic core 18, which serve as the heat generating mechanism of the present embodiment, function as a magnetic-field generating unit that generates an alternating magnetic field when alternating current is caused to flow in the exciting coil 19, and that induces current that flows in the heat generating layer 13b in the circumferential direction, due to the alternating magnetic field.

The holder 17 holds the sliding member 14 so that the sliding member 14 is positioned at a position at which the sliding member 14 faces the pressing roller 15 via the fixing film 13. The holder 17 is in contact with the inner surface of the fixing film 13, at a position on the outside of the nip portion N; and has a function to guide the trajectory of rotation of the fixing film 13. The stay 16 is a metal member for increasing the stiffness of the fixing apparatus 12. Each of the temperature sensors 22 and 23 is a sensor that detects the temperature of the fixing film 13.

The fixing apparatus 12 causes the fixing film 13 to generate heat, by energizing the exciting coil 19; and causes the fixing film 13 to heat an image formed on the recording material P, while causing the fixing film 13 and the pressing roller 15 to nip and convey the recording material P in the nip portion N.

In the following description and the drawings, the direction of the generating line (longitudinal line) of the fixing film 13 is defined as a longitudinal direction X of the fixing apparatus 12, or a longitudinal direction X. The moving direction of the recording material P in the nip portion N is defined as a recording-material conveyance direction Y The recording-material conveyance direction Y is a direction which is orthogonal to the longitudinal direction X, and in which the surface of the fixing film 13 and the surface of the pressing roller 15 move in the nip portion N. The direction orthogonal to both of the longitudinal direction X and the recording-material conveyance direction Y is defined as a vertical direction Z.

The longitudinal direction X is an example of a first direction. The recording-material conveyance direction Y is an example of a second direction. The vertical direction Z is an example of a third direction.

The fixing film 13 has a layer structure that includes a base layer 13a, the heat generating layer 13b, a protection layer 13c, and a surface layer 13d. The base layer 13a, the heat generating layer 13b, the protection layer 13c, and the surface layer 13d are formed in this order in a direction that extends from the inner circumference side toward the outer circumference side of the fixing film 13 in the thickness direction of the fixing film 13. The base layer 13a is an example of an inner layer formed on the inner circumference side of the heat generating layer 13b and made of synthetic resin. The protection layer 13c is an example of an outer layer formed on the outer circumference side of the heat generating layer 13b and made of synthetic resin. The surface layer 13d is a layer (release layer) formed on the outermost circumference side of the fixing film 13.

Preferably, the base layer 13a has an electrical resistance value higher than that of the heat generating layer 13b, and has heat resistance. Preferably, the material of the base layer 13a is an insulator. For example, the material of the base layer 13a is an insulating heat-resistant resin such as polyimide (PI), polyamide-imide (PAI), polyether ether ketone (PEEK), or polyether sulfone (PES). In addition, it is preferable that the base layer 13a, which constitutes the inner surface of the fixing film 13, have higher lubricity and wear resistance, because the base layer 13a slides on the sliding member 14. The base layer 13a of the present embodiment is a layer made of polyimide and having an inner diameter of 30 mm, a length of 240 mm in the longitudinal direction X, and a thickness of about 40 μm.

For example, the base layer 13a is formed in the following method. First, a mold release treatment is performed on the surface of a cylindrical stainless-steel mold having an outer diameter of 30 mm, and a coating is formed on the surface of the mold. The coating is formed by coating the surface of the mold with a polyimide precursor solution (product name: U-varnish S made by Ube Industries, Ltd.) by using the soaking method. In addition, the solvent of the coating is evaporated by drying the coating at 140 °C for 30 minutes, and then is imidized by sintering the coating at 200 °C for 30 minutes and 400 °C for 30 minutes. In this manner, the base layer 13a is formed.

The heat generating layer 13b is a layer of a heat generating resistor that generates the Joule heat when energized. The heat generating layer 13b is made of a material whose electrical resistance value is lower than those of the base layer 13a and the protection layer 13c. Preferably, the material of the heat generating layer 13b is a pure metal such as iron, copper, silver (Ag), aluminum, nickel, chromium, or tungsten, or an alloy, such as a stainless steel (e.g., SUS304) that contains the pure metal, or Nichrome, which has a lower volume resistivity. In other words, the heat generating layer 13b is made of a metal material. In another case, the heat generating layer 13b may be made of a conductive resin, such as carbon-fiber reinforced plastic (CFRP) or a carbon nanotube resin, if the conductive resin has a sufficiently low volume resistivity. The heat generating layer 13b can be formed by using a known method, such as coating, plating, sputtering, or vapor deposition. Note that the base layer 13a, the protection layer 13c, and the surface layer 13d, other than the heat generating layer 13b, can also be formed by using a known film manufacturing method, such as dipping, spray coating, extrusion molding, or inflation molding.

For example, the heat generating layer 13b is formed in the following method. First, a coating is formed on the base layer 13a by using an ink (DNS163 made by Daicel Corporation) that contains Ag nanoparticles, and using the inkjet method. After that, the coating is sintered at 300 °C for 30 minutes, so that the heat generating layer 13b is formed so as to have a thickness of about 1.0 μm. The heat generating layer 13b may not be formed on the whole of the base layer 13a having a length of 240 mm in the longitudinal direction X, and may be formed on part of the base layer 13a whose length is larger than the maximum paper width that can be handled by the printer 1. In the present embodiment, the maximum paper width that can be handled by the printer 1 is 215.9 mm that is of the Letter size. Thus, in the present embodiment, the heat generating layer 13b is formed so as to have a total width of 220 mm in the longitudinal direction X: 110 mm on the right side with respect to a center position of the base layer 13a and 110 mm on the left side with respect to the center position.

Preferably, the protection layer 13c has an electrical resistance value higher than that of the heat generating layer 13b, and has heat resistance. Preferably, the material of the protection layer 13c is an insulator. For example, the material of the protection layer 13c is an insulating heat-resistant resin such as polyimide (PI), polyamide-imide (PAI), polyether ether ketone (PEEK), or polyether sulfone (PES). The protection layer 13c may contain thermally-conductive filler for ensuring the heat transfer property. By increasing the heat transfer property of the protection layer 13c, the heat generated from the heat generating layer 13b can be efficiently transferred to the outer surface of the fixing film 13.

The protection layer 13c of the present embodiment is a layer made of polyamide-imide and having a thickness of about 49 μm. For example, the protection layer 13c is formed by coating the whole of the heat generating layer 13b with a PAI solution (VYLOMAX HR-16NN made by TOYOBO CO., LTD.) by using the ring coating, and then sintering the coating at 280 °C for 30 minutes.

In the present embodiment, the position of a neutral axis of the fixing film 13 can be adjusted by adjusting the thickness of the protection layer 13c or another layer. The neutral axis of the fixing film 13 is a line of intersection formed where a neutral plane and an imaginary plane orthogonal to the longitudinal direction X intersect each other. In the neutral plane, no strain occurs when bending deformation occurs in the fixing film 13 such that the shape of a cross section of the fixing film 13 viewed in the longitudinal direction X deforms. Note that in the bending deformation, when viewed in the longitudinal direction X, the inner circumferential surface of the fixing film 13 is compressed in the circumferential direction, and the outer circumferential surface of the fixing film 13 is expanded in the circumferential direction. The position of the neutral axis of the fixing film 13 can be determined, based on the thickness and modulus of elasticity (Young's modulus) of each layer of the fixing film 13.

Preferably, the surface layer 13d has high releasability to toner, and heat resistance. Preferably, the material of the surface layer 13d is a fluororesin, such as PFA, PTFE, FEP, or ETFE, that has good releasability and heat resistance. Note that PFA stands for tetrafluoroethylene-perfluoro alkylvinyl ether copolymer, PTFE stands for polytetrafluoroethylene, and FEP stands for tetrafluoroethylene-hexafluoropropylene copolymer. In addition, ETFE stands for ethylene tetrafluoroethylene. The surface layer 13d of the present embodiment is a PFA resin tube (product name: 950HP-Plus made by Chemours-Mitsui Fluoroproducts Co., Ltd.) having a thickness of about 30 μm, and covers the protection layer 13c.

Note that although the description has been made, in the present embodiment, for the configuration in which the surface layer 13d and the protection layer 13c (i.e., an outer layer or a layer on the outer circumference side of the heat generating layer 13b) are disposed adjacent to each other, an elastic layer made of an elastic material, such as sponge or rubber, may be disposed between the surface layer 13d and the protection layer 13c. In a case where the elastic layer is disposed, the surface layer 13d deforms in accordance with unevenness of the surface of a recording material, so that the close-contact property of the surface layer 13d to a toner image increases. As a result, unevenness in heating the recording material and the toner image reduces, so that an image having less unevenness in gloss can be obtained. In addition, a primer layer may be disposed for increasing adhesiveness between layers. In addition, a layer that constitutes the inner surface of the fixing film 13 may be disposed on the inner circumferential side of the base layer 13a.

Preferably, the sliding member 14 has good sliding property to the inner surface of the fixing film 13, and heat resistance. The sliding member 14 of the present embodiment includes a base member, and a surface layer formed on a surface of the base member that slides on the fixing film 13. Preferably, the material of the base member is a heat-resistant resin, such as PI, PAI, PEEK, or PES, that has good heat resistance, or a metal such as aluminum, iron, or copper. In the present embodiment, the base member is made of pure aluminum and has a thickness of 0.8 mm. The surface layer of the sliding member 14 of the present embodiment is a PTFE coating having a thickness of about 30 μm, less slide resistance to the inner surface of the fixing film 13, and good heat resistance and wear resistance. In addition, heat-resistant lubricant is applied between the sliding member 14 and the fixing film 13 for further reducing the slide resistance between the sliding member 14 and the fixing film 13. Preferably, the lubricant is a fluorine-based or silicone-based grease or oil. In the present embodiment, the lubricant used is a fluorine grease that contains fluorine oil as a base material, and PTFE as a thickener.

The sliding member 14 is held by the holder 17. The holder 17 includes a groove portion (recess portion) which is formed on the pressing roller 15 side in the vertical direction Z, and in which the sliding member 14 is fit. In addition, a surface of the holder 17 opposite to the sliding member 14 in the vertical direction Z is supported by the stay 16. The stay 16 is a metal member whose cross section is U-shaped. Each of the sliding member 14, the holder 17, and the stay 16 is a member elongated in the longitudinal direction X and inserted in the internal space of the fixing film 13.

The pressing roller 15 is a roller having an outer diameter of 30 mm and including a core metal 15a, an elastic layer 15b, and a surface layer 15c. The elastic layer 15b coaxially covers the outer circumference side of the core metal 15a, and the surface layer 15c serves as a surface layer. Preferably, the elastic layer 15b is made of a material, such as silicone rubber, fluororubber, or fluorosilicone rubber, that has good heat resistance. The elastic layer 15b of the present embodiment has a thickness of about 4 mm, and is made of silicone rubber. Preferably, the surface layer (release layer) 15c is made of a material having good releasability and heat resistance. Preferably, the surface layer (release layer) 15c is made of a fluororesin, such as PFA, PTFE, or FEP. The surface layer 15c of the present embodiment has a thickness of about 50 μm, and is made of a PFA resin. Both end portions of the core metal 15a are rotatably held by conductive bearings fixed to side plates that are part of the frame of the fixing apparatus 12.

In addition, a pressing spring 21a is disposed between one of both end portions of the stay 16 and a spring receiving member 20a disposed in the frame of the fixing apparatus 12, and a pressing spring 21b is disposed between the other of both end portions of the stay 16 and a spring receiving member 20b disposed in the frame of the fixing apparatus 12 (FIG. 3). By the urging force of the pressing springs 21a and 21b, the stay 16, the holder 17, and the sliding member 14 are urged toward the pressing roller 15 in the vertical direction Z. In the present embodiment, pressing force having a total pressure of 100 N to 500 N (about 10 kgf to about 50 kgf) is applied to the stay 16. With this operation, the sliding member 14 and the pressing roller 15 are abutted against each other via the fixing film 13, so that the nip portion N is formed.

The pressing roller 15 is driven and rotated in a rotational direction (i.e., a clockwise direction in FIG. 2) along the recording-material conveyance direction Y, by the driving force applied from a motor that is a driving source, to the pressing roller 15. The fixing film 13 rotates in a counterclockwise direction in FIG. 2, in accordance with the rotation of the pressing roller 15 by the frictional force applied from the pressing roller 15 to the fixing film 13 in the nip portion N.

The magnetic core 18 and the exciting coil 19 are disposed in a space surrounded by the holder 17 and the stay 16 whose cross section is U-shaped. That is, the magnetic core 18 and the exciting coil 19 (which are a magnetic-field generating unit), which serve as a heat generating mechanism of the present embodiment, are inserted in the internal space of the fixing film 13.

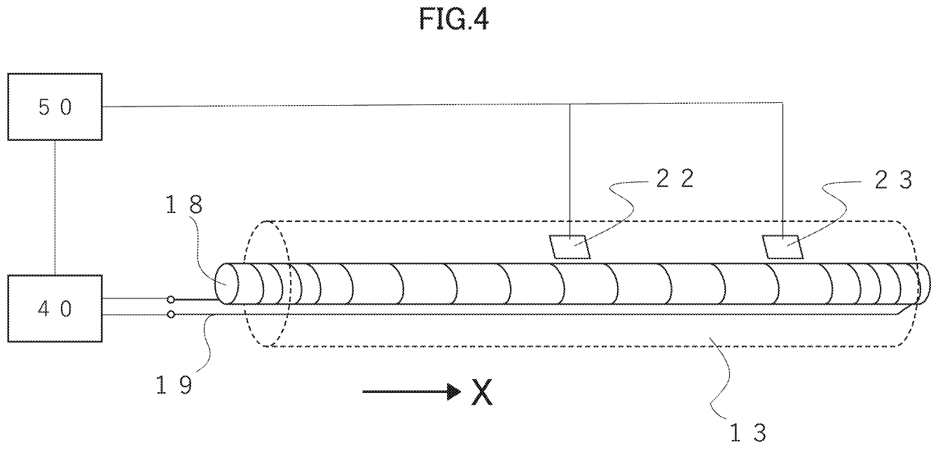

FIG. 4 is a perspective view schematically illustrating the magnetic core 18 and the exciting coil 19. As illustrated in FIG. 4, the exciting coil 19 is formed so as to helically extend along the longitudinal direction X (i.e., a first direction). The exciting coil 19 of the present embodiment is wound around the outer circumferential surface of the magnetic core 18. The magnetic core 18 has a cylindrical shape having end portions. When viewed in the longitudinal direction X, the magnetic core 18 is disposed at a substantially central portion (face center) of the fixing film 13.

The magnetic core 18 serves as a magnetic-path forming member that induces lines of magnetic force (magnetic flux) of the alternating magnetic field generated by the exciting coil 19, and that forms a path (magnetic path) of the lines of magnetic force. The material of the magnetic core 18 is a magnetic material which, in particular, has lower iron loss (hysteresis loss and eddy-current loss) and higher relative permeability. Preferably, the material of the magnetic core 18 is a soft magnetic material having high permeability, such as sintered ferrite or ferrite resin. The magnetic core 18 may have any cross-sectional shape as long as the magnetic core 18 can be accommodated in the hollow portion of the fixing film 13. Preferably, the magnetic core 18 has a shape that allows the cross-sectional area of the magnetic core 18 to be increased as much as possible. The cross-sectional shape of the magnetic core 18 may not necessarily be a circular shape. However, it is preferable that the cross-sectional shape of the magnetic core 18 be substantially circular because if the wire member (winding wire) of the exciting coil 19 wound around the magnetic core 18 has a shorter length, the copper loss (coil-current Joule loss) can be made lower. The magnetic core 18 of the present embodiment has a circular cross section having a diameter of 10 mm, and has a length of 280 mm. The material of the magnetic core 18 is a soft ferrite.

The exciting coil 19 is formed by helically winding a copper wire member (single conducting wire) around the magnetic core 18. The copper wire member has a diameter of 1 to 2 mm, and is covered with heat-resistant PI. The number of turns of the exciting coil 19 is 18. The direction of the axis of helix of the exciting coil 19 is a direction (i.e., the longitudinal direction X) parallel with the axial direction of the magnetic core 18, and with the direction of the generating line of the fixing film 13. The exciting coil 19 is connected with a power supply 40 having an inverter system and capable of outputting high-frequency current. If high-frequency current flows in the exciting coil 19, induced current flows in the heat generating layer 13b due to a below-described principle, and the heat generating layer 13b generates heat.

The temperature of the fixing film 13 is detected by the temperature sensors 22 and 23. The temperature sensors 22 and 23 are connected to the control portion 50. The temperature sensor 22 is disposed substantially at the center position of the fixing film 13 in the longitudinal direction X, and is used mainly for controlling the temperature of the fixing film 13 so that the temperature becomes a target temperature suitable for the fixing operation. The temperature sensor 23 is disposed in the vicinity of an end portion of the fixing film 13 in the longitudinal direction X, and is used mainly for controlling the temperature of the fixing film 13 so that the temperature of the fixing film 13 does not exceed a heat-resistant temperature. Since the temperature sensors 22 and 23 have an identical configuration, the temperature sensor 22 will be described in detail, as an example.

As illustrated in FIG. 2, the temperature sensor 22 includes a plate spring 22a whose one end is fixed to the stay 16, a thermistor 22b disposed on the other end of the plate spring 22a and serving as a temperature detection element, and a sponge 22c disposed between the plate spring 22a and the thermistor 22b. The surface of the thermistor 22b is covered with a polyimide tape having a thickness of 50 μm, for ensuring electrical insulation. The sponge 22c functions as a heat-insulating material for the thermistor 22b, and also has a function for causing the thermistor 22b to flexibly fit to the fixing film 13 that is an object to be measured.

Voltage values (output values) from the temperature sensors 22 and 23 are converted from analog to digital (A/D) and sent to the control portion (control circuit) 50. The control portion 50 calculates temperatures, based on the voltage values that the control portion 50 has received. In a case where the fixing operation is performed, in the nip portion N, on a toner image borne by the recording material P, the control portion 50 controls the amount of high-frequency current supplied to the exciting coil 19, for causing the temperature of a recording-material passage area of the fixing film 13 to become equal to a target temperature suitable for the fixing operation. In addition, the control portion 50 controls the frequency of the AC current (alternating current) that flows in the exciting coil 19. Furthermore, the control portion 50 performs the control so that the heat-resistant temperature of the fixing film 13 is not exceeded.

### 3. Principle of Heating

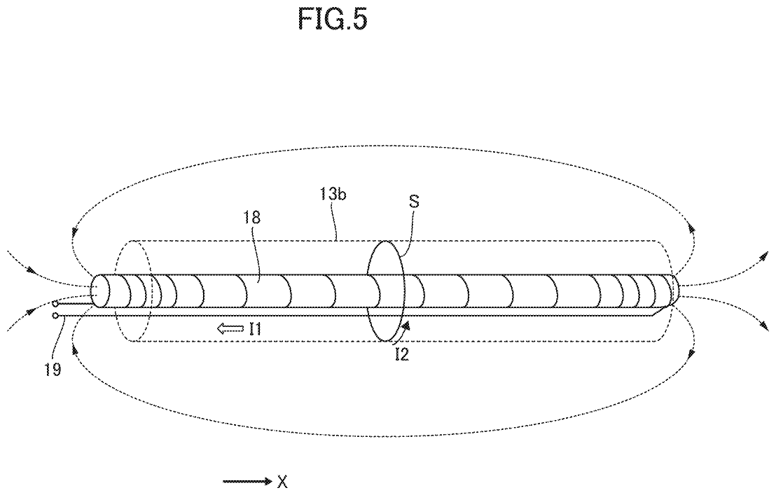

FIG. 5 is a conceptual diagram illustrating a moment at which the current that flows in the exciting coil 19 in a direction indicated by an arrow I1 is increasing. In the fixing apparatus 12 of the present embodiment, if high-frequency current flows in the exciting coil 19, a magnetic field is formed, and in the magnetic field, most (90% or more) of the magnetic flux output from one end of the magnetic core 18 returns to the other end of the magnetic core 18 through the external space of the fixing film 13. In FIG. 5, a symbol S indicates part of a closed circuit of the heat generating layer 13b. The change in magnetic flux that passes through the closed circuit produces an electromotive force, so that induced current (circumferential current) flows in the heat generating layer 13b of the fixing film 13 in a direction indicated by an arrow I2, in the circumferential direction of the fixing film 13 (the induced current flows in the direction so as to cancel the change in the magnetic field). In reality, the induced current flows in the whole of the heat generating layer 13b formed in the longitudinal direction X of the fixing film 13. That is, the configuration can be regarded as an open-magnetic-circuit transformer in which the exciting coil 19 and the heat generating layer magnetically couple with each other. In this case, the exciting coil 19 can be regarded as a primary coil having the number of turns of 18, and the heat generating layer can be regarded as an infinite number of secondary coils formed in the longitudinal direction X and each having the number of turns of 1. In addition, the heat generating layer 13b is caused to generate heat, by the Joule heat produced by the induced current.

Thus, in the present embodiment, due to the principle of induction heating, part of electric power supplied to the exciting coil 19 is converted to heat, and the fixing film 13 itself generates heat. By using this heat, the fixing apparatus 12 thermally fixes an image formed on a recording material, to the recording material by heating the image.

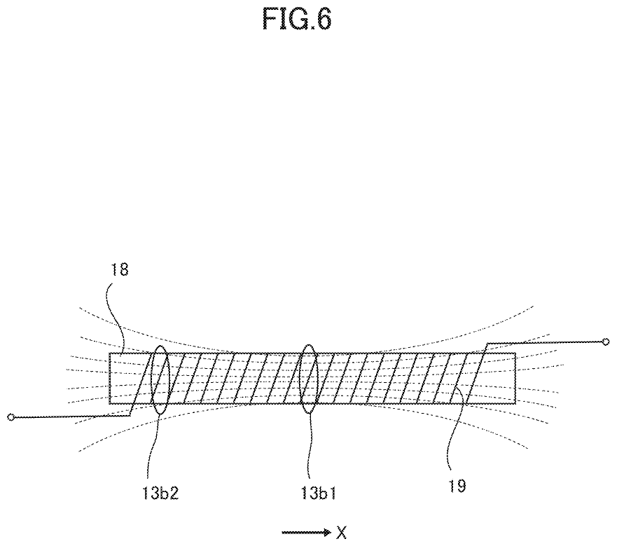

One of features of the induction heating system of the present embodiment is that if the frequency (driving frequency) of the alternating current that flows in the exciting coil 19 (hereinafter simply referred to as alternating current) is increased, the amount of heat generation of a center portion of the fixing film 13 in the longitudinal direction X decreases relative to the amount of heat generation of an end portion of the fixing film 13. Note that the frequency of the alternating current that flows in the exciting coil 19 is the same as the frequency of the alternating magnetic field generated by the alternating current. This phenomenon is considered to be caused by the fact that the inductance of a center portion of the heat generating layer 13b in the longitudinal direction X is higher than the inductance of an end portion of the heat generating layer 13b in the longitudinal direction X because the fixing film 13 has a finite length. FIG. 6 is a schematic diagram for illustrating the difference in magnetic flux between the end portion and the center portion of the heat generating layer 13b. Note that in the following description, the center portion of the heat generating layer 13b in the longitudinal direction X is simply referred to as a center portion or a center portion of the heat generating layer 13b, as illustrated in FIG. 6. In addition, the end portion of the heat generating layer 13b in the longitudinal direction X is simply referred to as an end portion or an end portion of the heat generating layer 13b.

If the alternating electromotive force is generated in the circumferential direction of the heat generating layer 13b by the alternating magnetic field, alternating current flows, and the Joule heat is produced by the resistance component of the heat generating layer 13b. However, if the heat generating layer 13b has an inductance component, the phase delay of the alternating current to the alternating electromotive force occurs, so that the power factor decreases and the amount of the Joule heat decreases. The amount of the Joule heat decreases more significantly as the inductance increases. For this reason, the amount of heat generation of the end portion of the heat generating layer 13b becomes larger than the amount of heat generation of the center portion of the heat generating layer 13b. In addition, if the frequency of the alternating current is increased, the amount of heat generation of the center portion of the heat generating layer 13b decreases more relatively to the amount of heat generation of the end portion of the heat generating layer 13b.

On the other hand, since each of the magnetic core 18 and the exciting coil 19 of the present embodiment has a finite length, the magnetic flux that passes through the heat generating layer 13b, which forms a closed circuit, varies in accordance with positions in the longitudinal direction X. For example, as illustrated in FIG. 6, in a case where the exciting coil 19 is formed by uniformly winding a wire member, the magnetic flux that passes through a center portion 13b1 of the heat generating layer 13b has a larger value than that of the magnetic flux that passes through an end portion 13b2 of the heat generating layer 13b. Thus, the electromotive force of the center portion 13b1 is larger than the electromotive force of the end portion 13b2. The difference in electromotive force also varies, depending on how the wire member of the exciting coil 19 is wound. For example, if the winding density of the exciting coil 19 in the end portion 13b2 is made larger than the winding density of the exciting coil 19 in the center portion 13b1, the electromotive force of the end portion 13b2 can be made larger.

That is, even though the difference in the amount of heat generation is caused by the difference in inductance of the heat generating layer 13b in the longitudinal direction X (the amount of heat generation of the center portion 13b1 is smaller than the amount of heat generation of the end portion 13b2), the amount of heat generation of the heat generating layer 13b in the longitudinal direction X can be made substantially constant at a predetermined frequency of the alternating current, by using the exciting coil 19 with a finite length and adjusting the winding pattern. In addition, the amount of heat generation of the end portion 13b2 of the heat generating layer 13b can be decreased by decreasing the frequency of the alternating current from the predetermined frequency.

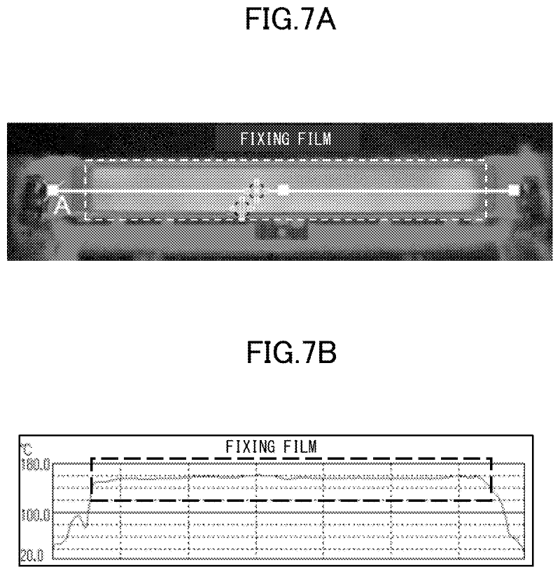

FIG. 7A is a photograph of the fixing film 13 that was generating heat. The photograph was captured with an infrared camera. In FIG. 7A, the driving frequency of the power supply 40 was set at 70 kHz in the induction heating system of the present embodiment. In addition, the temperature control was performed so that the center portion of the fixing film 13 in the longitudinal direction X has a temperature of 160 °C. The driving frequency of the power supply 40 is the same as the frequency of the alternating current that flows in the exciting coil 19. In the photograph, a portion surrounded by a dotted line indicates the fixing film 13, and a whiter and brighter portion indicates that the portion of the fixing film 13 has a higher temperature. The temperature of the fixing film 13 illustrated in FIG. 7A is substantially constant across the whole of the fixing film 13 in the longitudinal direction X, although slight unevenness is seen.

FIG. 7B is a graph in which the temperature of a portion of the fixing film 13 indicated by a section line A illustrated in FIG. 7A is plotted. In FIG. 7B, the temperature of the fixing film 13 is about 160 °C, and the fixing film 13 has a substantially constant temperature distribution in the longitudinal direction X. This is because the winding pattern of the exciting coil 19 was adjusted so that the fixing film 13 has a substantially constant temperature distribution in a case where the driving frequency of the power supply 40 is 70 kHz.

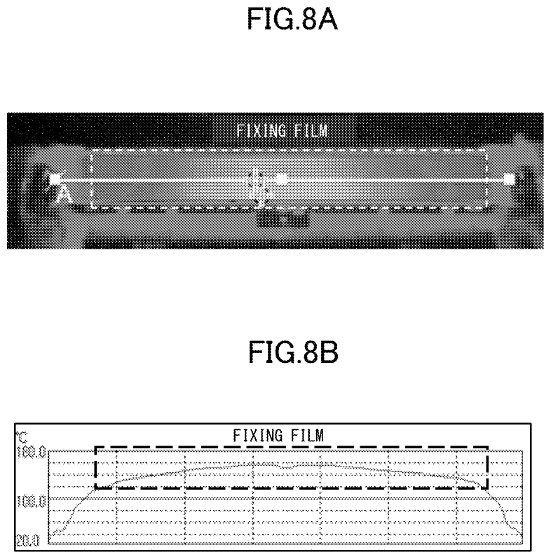

FIG. 8A is a photograph of the fixing film 13 in a case where the driving frequency of the power supply 40 was decreased to 45 kHz. The photograph was captured with an infrared camera. As illustrated in FIG. 8A, the image of the fixing film 13 darkens gradually from a center portion toward an end portion of the fixing film 13, and the end portion of the fixing film 13 has a lower temperature. FIG. 8B is a graph in which the temperature of a portion of the fixing film 13 indicated by a section line A illustrated in FIG. 8A is plotted. In FIG. 8B, although the center portion of the fixing film 13 has a temperature of about 160 °C that is a control value toward which the control portion 50 performs the control, the temperature of the fixing film 13 decreases more as temperature is measured at a position closer to the end portion. At the farthest portion of the fixing film 13, the temperature of the fixing film 13 decreased to about 110 °C. Thus, in the induction heating system of the present embodiment, the heat generation distribution can be changed by changing the driving frequency of the power supply 40.

### 4. Shape of Sliding Member (Nip Forming Member)

Next, a preferable shape of the sliding member 14 will be described. Since the main component of toner is a thermoplastic resin, the toner softens as the temperature rises. The toner on the recording material P receives heat from the fixing film 13 in the nip portion N of the fixing apparatus 12, so that the temperature of the toner rises. For this reason, when the toner passes through the exit of the nip portion N (i.e., the downstream edge in the recording-material conveyance direction Y), the toner has the highest temperature in a period of time in which the toner passes the nip portion N.

Thus, for fixing the toner to the recording material P by deforming the toner by pressing the toner, it is efficient to press the toner strongly in the vicinity of the exit of the nip portion N at which the toner softens more. That is, it is preferable that the pressure distribution be formed such that the peak position of pressure in the nip portion N is shifted to the downstream side of the nip portion N in the recording-material conveyance direction Y.

In addition, the longer the toner on the recording material and the fixing film 13 are in contact with each other, the higher the toner temperature rises. Thus, for fixing the toner to the recording material P, it is preferable that the width of the nip portion N in the recording-material conveyance direction Y be larger.

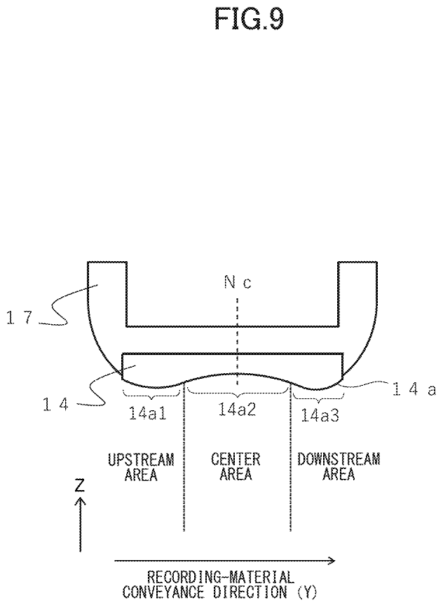

FIG. 9 is an example of the shape of the sliding member (nip forming member) 14. FIG. 9 illustrates a cross-sectional shape of the sliding member 14 taken along an imaginary plane perpendicular to the longitudinal direction X. Hereinafter, the midpoint of the nip portion N (i.e., the contact area between the fixing film 13 and the pressing roller 15) in the recording-material conveyance direction Y is defined as a center position Nc of the nip portion N. In addition, an area of the nip portion N that includes the center position Nc is defined as a center area of the nip portion N. In addition, an area of the nip portion N that includes the upstream edge of the nip portion N in the recording-material conveyance direction Y is defined as an upstream area of the nip portion N. In addition, an area of the nip portion N that includes the downstream edge of the nip portion N in the recording-material conveyance direction Y is defined as a downstream area of the nip portion N.

In the sliding member 14 of the present embodiment, a surface (i.e., a sliding surface 14a) that slides on the fixing film 13 is curved. In addition, the sliding member 14 includes an upstream-side projection portion 14a1, a recess portion 14a2, and a downstream-side projection portion 14a3. The downstream-side projection portion 14a3 is an example of a projection portion, and the upstream-side projection portion 14a1 is an example of a second projection portion.

The sliding surface 14a of the sliding member 14 is curved so as to be recessed toward the side (i.e., the upper side in FIG. 9) separated from the pressing roller 15 in the vertical direction Z, so that the close-contact property between the pressing roller 15 and the sliding member 14 can be increased. In addition, since the sliding surface 14a is curved, the width of the nip portion N can be made larger than that in a case where the sliding surface 14a of the sliding member 14 is flat.

However, if the curvature radius of the recess portion 14a2 is smaller than the curvature radius of the outer circumferential surface of the pressing roller 15, a center area of the recess portion 14a2 may be applied with a lower pressure than the pressure applied to the nip portion N (i.e., decrease in pressure). Thus, it is preferable that the curvature radius of the recess portion 14a2 be equal to or larger than the curvature radius of the outer circumferential surface of the pressing roller 15. Since the diameter of the pressing roller 15 of the present embodiment is 30 mm, the curvature radius of the outer circumferential surface of the pressing roller 15 is 15 mm. Thus, the curvature radius of the recess portion 14a2 of the present embodiment is set at 20 mm. In this case, the width of the nip portion N can be increased, without excessively increasing the amount of deformation of the pressing roller 15.

In addition, in the present embodiment, since the downstream-side projection portion 14a3 that serves as a projection portion is formed in the sliding surface 14a of the sliding member 14, the peak position of the pressure distribution of the nip portion N is positioned in the downstream area of the nip portion N. The downstream-side projection portion 14a3 is a projection portion that is part of the sliding surface 14a, and that projects toward the pressing roller 15 side (i.e., the downward side in FIG. 9) in the vertical direction Z. The position of the top of the downstream-side projection portion 14a3 in the vertical direction Z is positioned closer to the pressing roller 15 side (i.e., the downward side in FIG. 9) than the position of the top of the upstream-side projection portion 14a1 in the vertical direction Z is. In such a configuration, the peak position of the pressure distribution of the nip portion N is positioned in the downstream area of the nip portion N, so that the fixability of toner can be increased.

For increasing the fixability, it is preferable that the curvature radius of the downstream-side projection portion 14a3 be decreased. This is because the peak pressure of the pressure distribution of the nip portion N is increased and the toner can be more effectively deformed. However, as the curvature radius of the downstream-side projection portion 14a3 decreases, the bending stress of the fixing film 13, which rotates along the trajectory of rotation formed along the sliding surface 14a, increases.

In a case where the trajectory of rotation of the fixing film 13 includes a portion that bends the fixing film 13 so as to have a larger curvature, the bending fatigue is produced by the bending deformation of the heat generating layer 13b. In addition, the bending fatigue causes cracks and permanent deformation of the heat generating layer 13b over a long-time use, so that the electrical resistance of the heat generating layer 13b may increase, possibly causing the decrease in the amount of heat generation and the failure of fixing of images.

For this reason, in the present embodiment, the minimum value of the curvature radius of the downstream-side projection portion 14a3 is set at 5.0 mm. On the other hand, the minimum value of the curvature radius of the upstream-side projection portion 14a1 of the sliding surface 14a may be set larger than 5.0 mm. That is, the minimum value of the curvature radius of the downstream-side projection portion 14a3 (i.e., a projection portion) viewed in the longitudinal direction X may be smaller than the minimum value of the curvature radius of the recess portion 14a2 viewed in the longitudinal direction X, and than the minimum value of the curvature radius of the upstream-side projection portion 14a1 (i.e., a second projection portion) viewed in the longitudinal direction X. In this manner, the pressure applied to the downstream area of the nip portion N can be increased by the downstream-side projection portion 14a3.

Note that the minimum value of the curvature radius of the downstream-side projection portion 14a3 and the minimum value of the curvature radius of the upstream-side projection portion 14a1 may be equal to each other (in this case, two portions of the fixing film 13, a portion that contacts the downstream-side projection portion 14a3 and a portion that contacts the upstream-side projection portion 14a1, have the maximum curvature).

### 5. Neutral Axis of Fixing Film

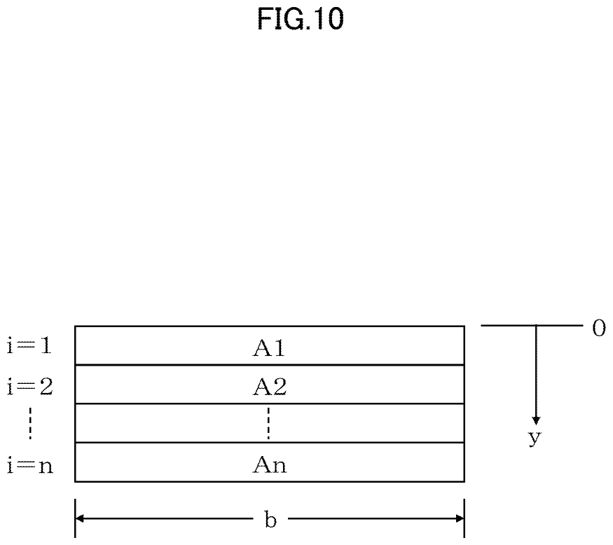

Next, the neutral axis of the fixing film 13 will be described. FIG. 10 illustrates a film-like member (belt-like member) having n layers. In FIG. 10, a parameter y represents a distance in the thickness direction of the film-like member, from the outer surface of the film-like member that serves as a reference (y=0). In addition, the cross-sectional area of an i-th layer from the outer surface is denoted by Ai, the width of the i-th layer is denoted by bi, and the modulus of elasticity (Young's modulus) of the i-th layer is denoted by Ei. In this case, a distance (y0) from the outer surface of the film-like member to the neutral axis is defined by the following equation.

$${y}_{0} = \frac{{\sum }_{i} ( {E}_{i} {\int }_{{A}_{i}} yd {A}_{i} )}{{\sum }_{i} ( {E}_{i} {A}_{i} )}$$

In a unit width (b=1), dAi=dyi. Thus, the distance (y0) from the outer surface of the film-like member to the neutral axis is expressed by the following equation.

$${y}_{0} = \frac{{\sum }_{i} ( {E}_{i} {\int }_{{A}_{i}} yd {y}_{i} )}{{\sum }_{i} ( {E}_{i} {y}_{i} )}$$

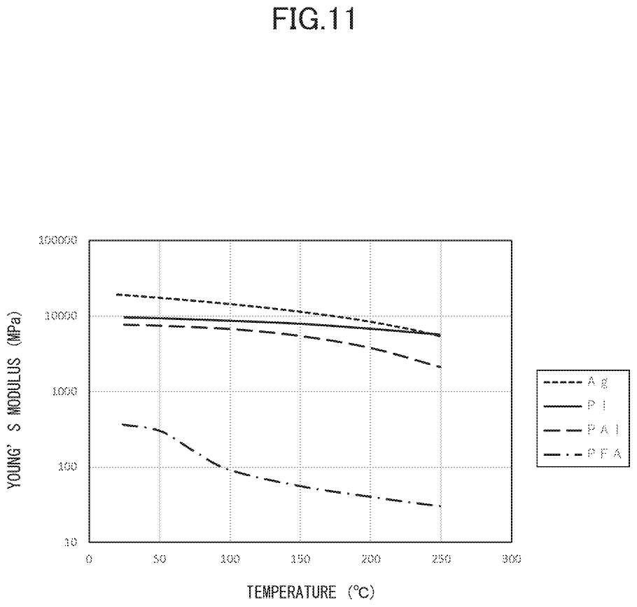

FIG. 11 is a graph illustrating the temperature dependence of Young's modulus of PFA used in the surface layer 13d of the present embodiment, PAI used in the protection layer 13c, Ag used in the heat generating layer 13b, and PI used in the base layer 13a. That is, the base layer 13a is made of PI (polyimide) that serves as a first resin material, and the protection layer 13c is made of PAI (polyamide-imide) that serves as a second resin material different from the first resin material. The heat generating layer 13b is made of Ag (silver) that is a metal material. The Young's modulus of the above-described materials decreases as the temperature rises, and the degree of decrease of the Young's modulus varies, depending on the materials.

Table 1 tabulates the thickness of each layer (made of a corresponding material) of the fixing film 13, and the Young's modulus of each layer that changes with temperature. That is, Table 1 tabulates the thickness of each layer, the Young's modulus at a target temperature (150 °C to 170 °C) suitable for the fixing process, and the Young's modulus at a temperature (230 °C) of a recording-material non-passage area formed when a small-sized recording material P passes through the fixing apparatus 12. The target temperature suitable for the fixing process varies, depending on the grammage or surface property of a recording material that passes through the fixing apparatus 12. In the present embodiment, the target temperature is in a range from 150 °C to 170 °C. In addition, the temperature of the recording-material non-passage area has its upper limit that is the heat-resistant temperature of each of members. In the present embodiment, the temperature of the recording-material non-passage area is set at 230 °C in consideration of margin for safety. As can be seen from Table 1 and FIG. 11, the temperature dependence of Young's modulus of the heat generating layer 13b is different from those of the base layer 13a, the protection layer 13c, and the surface layer 13d.

TABLE 1

| | THICKNESS | YOUNG'S MODULUS (MPa) | | | |
|---|---|---|---|---|---|
| | (μm) | 150 °C | 160 °C | 170 °C | 230 °C |
| PFA (SURFACE LAYER 13d) | 50 | 91.4 | 83.3 | 77.5 | 46 |
| PAI (PROTECTION LAYER 13c) | 48 | 5407 | 5098 | 4769 | 2743 |
| Ag (HEAT GENERATING LAYER 13b) | 1 | 11333 | 10733 | 10133 | 6533 |
| PI (BASE LAYER 13a) | 40 | 7853 | 7655 | 7436 | 6065 |

Table 2 tabulates a calculated neutral-axis position (i.e., a distance from the surface of the fixing film 13 to the neutral axis) under the same temperature condition as that in Table 1, and the calculated amount of shift of the neutral-axis position from the center of the heat generating layer 13b.

TABLE 2

| | 150 °C | 160 °C | 170 °C | 230 °C |
|---|---|---|---|---|
| NEUTRAL-AXIS | 79.01 | 79.38 | 79.80 | 83.54 |
| POSITION (μm) | | | | |
| AMOUNT OF SHIFT FROM | −0.49 | −0.12 | +0.30 | +4.04 |
| CENTER OF HEAT | | | | |
| GENERATING LAYER (μm) | | | | |

Since the thickness of the heat generating layer 13b is 1 μm, the neutral axis exists in the heat generating layer 13b if the amount of shift from the center of the heat generating layer 13b is in a range of 0.5 μm. On the other hand, if the amount of shift from the center of the heat generating layer 13b is equal to or larger than +0.5, the neutral axis exists in the base layer 13a.

As can be seen from Table 2, in a case where the fixing film 13 is heated at 150 °C to 170 °C, the neutral axis of the fixing film 13 exists in the heat generating layer 13b. On the other hand, in a case where the fixing film 13 is heated at 230 °C, the neutral axis of the fixing film 13 is out of the heat generating layer 13b, and exists in the base layer 13a. Thus, in the present embodiment, the material and thickness of the base layer 13a, the heat generating layer 13b, and the protection layer 13c are selected so that the neutral axis exists in the heat generating layer 13b at the target temperature of 150 °C to 170 °C suitable for the fixing process.

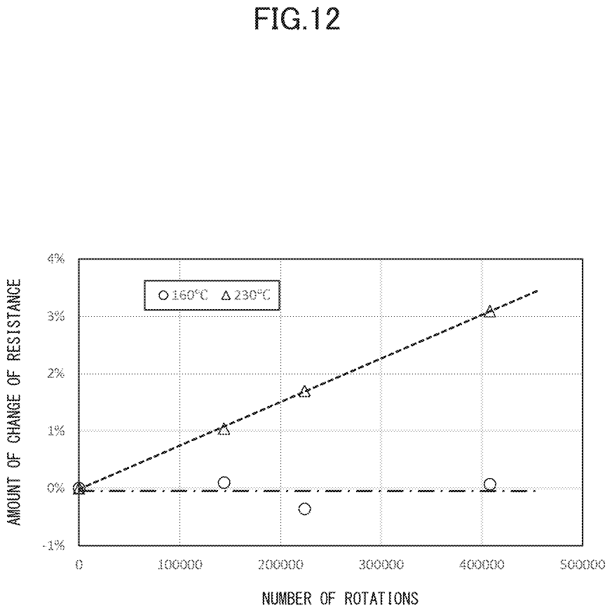

FIG. 12 illustrates the increase of resistance of the heat generating layer 13b obtained in a case where the fixing film 13 was caused to run idle at 160 °C and 230 °C while flowing alternating current (AC current) in the exciting coil 19. The temperature of 160 °C corresponds to the target temperature, and the temperature of 230 °C corresponds to the temperature of the recording-material non-passage area. Note that in the following description, the idle running means causing the fixing film 13 to run idle, without causing the nip portion N of the fixing apparatus 12 to convey the recording material P. The horizontal axis of FIG. 12 represents the number of rotations of the fixing film 13. The vertical axis of FIG. 12 represents the amount of change of resistance in which the initial resistance value of the heat generating layer 13b is normalized as 1.

In FIG. 12, the driving frequency was set at 70 kHz so that the temperature of the fixing film 13 becomes substantially constant in the axial direction of the fixing film 13. In addition, the electrical resistance value of the heat generating layer 13b was calculated from a value of current that flowed in the exciting coil 19 when the exciting coil 19 was applied with an alternating-current voltage having a constant amplitude. As can be seen from FIG. 12, in a case where the temperature of the fixing film 13 was set at 160 °C, the electrical resistance value of the heat generating layer 13b hardly changed even when the number of rotations of the fixing film 13 was increased.

On the other hand, in a case where the temperature of the fixing film 13 was set at 230 °C, the electrical resistance value of the heat generating layer 13b increased as the number of rotations of the fixing film 13 was increased. The electrical resistance value of the heat generating layer 13b increased by about 3% at a point of time when the fixing film 13 had rotated 400,000 times. That is, the performance of the fixing film 13 deteriorates earlier in a case where the temperature of the fixing film 13 is set at 230 °C than in a case where the temperature of the fixing film 13 is set at 160 °C. The reason is as follows.

As described with reference to FIG. 9, the sliding member 14 of the present embodiment includes the downstream-side projection portion 14a3 formed in the vicinity of the exit of the nip portion N and serving as a projection portion that projects toward the pressing roller 15 side. At the downstream-side projection portion 14a3, the trajectory of rotation of the fixing film 13 viewed in the longitudinal direction X has the minimum curvature radius. In other words, the sliding member 14 that serves as a nip forming member is formed such that the curvature of the fixing film 13 viewed in the first direction has the maximum value at the contact portion between the fixing film 13 and the projection portion.

As a result, in a case where the fixing film 13 rotates while sliding on the sliding member 14, the fixing film 13 receives the maximum bending stress at the contact portion between the fixing film 13 and the projection portion (i.e., the downstream-side projection portion 14a3) of the sliding member 14.

The direction of the bending deformation of a portion of the fixing film 13 that contacts the projection portion (i.e., the downstream-side projection portion 14a3) is produced such that an outer surface of the fixing film 13 expands and an inner surface of the fixing film 13 contracts. That is, at the contact portion between the fixing film 13 and the projection portion (i.e., the downstream-side projection portion 14a3), the stress applied to a cross section of the fixing film 13, perpendicular to the fixing film 13 in the thickness direction and the longitudinal direction X of the fixing film 13, is tensile force on the outer circumference side of the fixing film 13 with respect to the neutral axis, and is compressing force on the inner circumference side of the fixing film 13 with respect to the neutral axis.

As described with reference to Table 2, in a case where the fixing film 13 is heated at 160 °C, the neutral axis of the fixing film 13 exists in the heat generating layer 13b. In a case where the neutral axis exists in the heat generating layer 13b, the heat generating layer 13b hardly receives both of the tensile force and the compressing force. Thus, it is considered that in a case where the temperature of the fixing film 13 was set at 160 °C, cracks hardly occurred in the heat generating layer 13b even when the number of rotations of the fixing film 13 was increased, so that the degree of increase of resistance value of the heat generating layer 13b was slight.

On the other hand, as can be seen from the above-described Table 2, in a case where the fixing film 13 is heated at 230 °C, the neutral axis of the fixing film 13 is out of the heat generating layer 13b, and exists in the base layer 13a. In this case, since the heat generating layer 13b is located on the outer circumference side with respect to the neutral axis of the fixing film 13, the tensile force is applied to the heat generating layer 13b at the contact portion between the projection portion (i.e., the downstream-side projection portion 14a3) and the fixing film 13. In the induction heating system used in the present embodiment, since the current flows in the circumferential direction of the fixing film 13, the increase of resistance in the circumferential direction becomes a problem. It is considered that microcracks of the heat generating layer 13b occurred when the heat generating layer 13b was expanded in the circumferential direction at the contact portion between the projection portion (i.e., the downstream-side projection portion 14a3) and the fixing film 13, and the cracks grew or accumulated as the number of rotations was increased, so that the resistance of the heat generating layer 13b increased.

From the result of the experiment shown in FIG. 12, it is confirmed that if the fixing film 13 receives the bending stress in a state where the fixing film 13 has a high temperature, the electrical resistance value of the heat generating layer 13b increases.

In addition, a recording-material conveyance durability test was performed by using an envelope having the COM10 size (104.8 mm×241.3 mm) (hereinafter simply referred to as an envelope). The envelope is conveyed to the nip portion N such that the center position of the envelope and the center position of the fixing film 13 are aligned with each other in the longitudinal direction X. Since the width of the envelope in the longitudinal direction X is 104.8 mm, the width of the recording-material passage area that the envelope passes in the nip portion N is 104.8 mm. In addition, both end portions of the heat generating layer 13b in the longitudinal direction X are the recording-material non-passage area that the envelope does not pass. Since the width of the heat generating layer 13b of the present embodiment is 220 mm, the width of the recording-material non-passage area is the sum of the width (57.6 mm) of one of both end portions of the heat generating layer 13b and the width (57.6 mm) of the other.

In the above-described recording-material conveyance durability test, the amount of heat generation of the end portion 13b2 of the heat generating layer 13b was reduced. Specifically, the target temperature of the fixing film 13 was set at 160 °C, and the driving frequency of the AC current (alternating current) that is caused to flow in the exciting coil 19 was set at 45 kHz. Note that the heat of the recording-material passage area of the fixing film 13 transfers to the envelope, but the heat of the recording-material non-passage area of the fixing film 13 does not transfer to the envelope. As a result, the temperature of the recording-material non-passage area tends to become higher than the temperature of the recording-material passage area. Thus, the control portion 50 controls the fixing apparatus 12 by using the following control method so that the temperature of the recording-material non-passage area does not exceed 230 °C.

The temperature of the recording-material non-passage area is detected by the temperature sensor 23. If the value detected by the temperature sensor 23 exceeds 227 °C, the control portion 50 temporarily stops the conveyance of the envelope and causes the fixing film 13 to run idle, and stops supplying current to the exciting coil 19. In addition, after the value detected by the temperature sensor 23 decreases to 222 °C, the control portion 50 restarts the conveyance of the envelope, and restarts to supply the current to the exciting coil 19. The control portion 50 performs such a control method every time the temperature of the recording-material non-passage area exceeds 230 °C.

In the recording-material conveyance durability test, 100,000 envelops were caused to pass through the nip portion N of the fixing apparatus 12. After that, the alternating current having a driving frequency of 70 kHz, which would cause the surface of the fixing film 13 to have substantially constant heat generation distribution in the longitudinal direction X, was caused to flow in the exciting coil 19. As a result, the temperature of the recording-material non-passage area of the fixing film 13 was decreased by 5 °C or more, compared with a case where the above-described recording-material conveyance durability test is not performed. This is because the fixing film 13 was rotated for a long time in a state where the high temperature of 230 °C was kept in the recording-material non-passage area, so that the electrical resistance value of the recording-material non-passage area, or the end portion 13b2 of the heat generating layer 13b, increased as described with reference to FIG. 12. In other words, unevenness in the electrical resistance value of the heat generating layer 13b was produced in the longitudinal direction X of the heat generating layer 13b. Since the exciting coil 19 is applied with alternating-current voltage having a constant amplitude, the induced current that flows in the end portion 13b2 decreases if the electrical resistance value of the end portion 13b2 of the heat generating layer 13b increases. As a result, the temperature of the end portion 13b2 of the heat generating layer 13b decreases relative to the temperature of the center portion 13b1.

In addition, a solid-black sample image was formed on a glossy paper sheet having the Letter size, and the image quality was checked. As a result, the gloss level of the sample image decreased by about 5 to 10 (GU) in an edge portion of the sample image in the longitudinal direction X, from the gloss level of a center portion of the sample image in the longitudinal direction X. This is because the unevenness in fixing performance occurred due to the decrease of temperature of the end portion 13b2 with respect to the temperature of the center portion 13b1 of the heat generating layer 13b.

### 6. Recovery Mode

Next, a recovery mode that can be executed by the control portion 50 of the present embodiment will be described. The control portion 50 of the present embodiment can perform the below-described recovery mode on the fixing film 13 in which the unevenness in the electrical resistance value has been produced in the longitudinal direction X of the heat generating layer 13b due to the increase of the electrical resistance value of the end portion 13b2 of the heat generating layer 13b with respect to the electrical resistance value of the center portion 13b1 of the heat generating layer 13b.

In the recovery mode, the control portion 50 sets the driving frequency of the AC current (alternating current) at 45 kHz, performs the control by using the temperature sensor 22 so that the center portion of the fixing film 13 has a temperature of 230 °C, and causes the fixing film 13 to run idle. As described above, at the driving frequency of 45 kHz, the amount of heat generation of the end portion 13b2 of the heat generating layer 13b is made smaller than the amount of heat generation of the center portion 13b1 of the heat generating layer 13b. As a result, the farthest portion of the fixing film 13 in the longitudinal direction X had a temperature of 180 °C, whereas the center portion of the fixing film 13 had a temperature of 230 °C. That is, in a case where the control portion 50 has performed the recovery mode, the temperature of the center portion of the fixing film 13 is higher than a target temperature (160 °C in the present embodiment) set for heating a toner image borne by the recording material P (envelope).

In addition, in a state where the above-described recovery mode was executed by the control portion 50, the fixing film 13 was caused to run idle for a period of time equal to a period of time in which 100,000 recording materials pass through the nip portion N. After that, the alternating current having a driving frequency of 70 kHz, which would cause the fixing film 13 to have substantially constant heat generation distribution in the longitudinal direction X, was caused to flow in the exciting coil 19. As a result, in the recording-material non-passage area of the fixing film 13, the decrease in temperature caused in the above-described recording-material conveyance durability test was lessened. In addition, the image quality of the above-described sample image formed on a glossy paper sheet having the Letter size was checked. As a result, the decrease in gloss level of an edge portion of the sample image in the longitudinal direction X was lessened, and the gloss level of the edge portion of the sample image was decreased by about 2 to 3 (GU). Note that the length of time in which the recovery mode is executed may be set as appropriate.

Thus, in the present embodiment, the recovery mode can be executed, and for the recovery mode, the driving frequency (45 kHz) is set so that the center portion of the fixing film 13 in the longitudinal direction X has a temperature higher than that of the end portion of the fixing film 13 in the longitudinal direction X. Note that a recording material having a width in the longitudinal direction X corresponding to the maximum width usable in the fixing apparatus 12 is defined as a recording material of a first size. In the present embodiment, the recording material of the first size is a recording material having the Letter size. In addition, a recording material having a width smaller than the width of the recording material of the first size in the longitudinal direction X is defined as a recording material of the second size. For example, the recording material of the second size is the above-described envelope having the COM10 size, a recording material having the A5 size, or a business card.

In a case where the fixing process is performed on the first-size recording material in the fixing apparatus 12, the frequency (driving frequency) of the AC current (alternating current) that is caused to flow in the exciting coil 19, is 70 kHz that would cause substantially constant heat generation distribution of the fixing film 13 in the longitudinal direction X. That is, the control portion 50 can perform a first mode in which the control portion 50 rotates the fixing film 13 while causing the nip portion N to convey the first-size recording material. In the present embodiment, since the driving frequency in the recovery mode that serves as a second mode is 45 kHz, the driving frequency (second frequency) in the second mode is lower than the driving frequency (first frequency) in the first mode.

In addition, the control portion 50 can lessen the unevenness in the electrical resistance value of the heat generating layer 13b, caused by the fixing process performed on small-sized (second size) recording materials such as the above-described envelopes, by executing the above-described recovery mode. As described above, if the fixing process is performed on small-sized recording materials, the electrical resistance value of the end portion 13b2 (that corresponds to the recording-material non-passage area) of the heat generating layer 13b increases.

However, by the control portion 50 executing the recovery mode, the electrical resistance value of the center portion 13b1 of the heat generating layer 13b also increases, so that the unevenness in the electrical resistance value of the heat generating layer 13b in the longitudinal direction X can be lessened. As a result, the unevenness in heating and fixing of the recording material and toner image can be reduced, so that the image defect can be reduced. That is, in a case where the small-sized recording material is conveyed, if the temperature of the end portion of the fixing film 13 reaches the upper limit of temperature that serves as a predetermined temperature (e.g., 230 °C), the control portion 50 executes the recovery mode at a predetermined timing. For example, the predetermined timing is a timing at which a period of time in which the temperature of the fixing film 13 has been the above-described upper limit of temperature exceeds a predetermined threshold, or a timing at which the number of rotations of the fixing film 13 in a state where the temperature of the fixing film 13 has been the upper limit of temperature exceeds a predetermined threshold.

In general, it is rare for as many as the 100,000 small-sized recording materials to be continuously conveyed to the fixing apparatus 12. In most cases, a certain number of small-sized recording materials is conveyed to the fixing apparatus 12, and after a while, other small-sized recording materials are conveyed to the fixing apparatus 12. Thus, the temperature of the recording-material non-passage area of the fixing film 13 may not reach the upper limit of temperature (which is a predetermined temperature of 230 °C in the present embodiment). For this reason, it is preferable that in a case where small-sized recording materials have been conveyed to the fixing apparatus 12 and the temperature of the recording-material non-passage area of the fixing film 13 is likely to reach the upper limit of temperature, the recovery mode be executed. In the recovery mode, the driving frequency of the alternating current that flows in the exciting coil 19 is decreased, and the fixing film 13 is caused to run idle in a state where the temperature of the center portion (i.e., the recording-material passage area) of the fixing film 13 is the upper limit of temperature.

The length of time in which the recovery mode is executed may be set in accordance with a period of time in which the temperature of the end portion of the fixing film 13 in the longitudinal direction X has been kept at or near the upper limit of temperature in the fixing process. For example, the length of time in which the recovery mode is executed may be set equal to the length of time in which the temperature of the end portion of the fixing film 13 in the longitudinal direction X has been kept at or near the upper limit of temperature in the fixing process. In another case, the length of time in which the recovery mode is executed may be 80% to 120% of the length of time in which the temperature of the end portion of the fixing film 13 in the longitudinal direction X has been kept at or near the upper limit of temperature in the fixing process.

Immediately after small-sized recording materials have passed through the fixing apparatus 12, the recording-material non-passage area of the fixing film 13 often has a high temperature. Thus, after the small-sized recording materials have passed through the fixing apparatus 12, the fixing film 13 may be caused to run idle and the supply of current to the exciting coil 19 may be stopped, in a break time. In addition, the above-described recovery mode may be executed after the temperature of the fixing film 13 decreases to some extent in the predetermined break time. In this case, the temperature of the center portion of the fixing film 13 in the longitudinal direction X can be more efficiently made higher than the temperature of the end portion of the fixing film 13.

A user who uses small-sized recording materials, such as recording materials having the COM10 size or the A5 size, may use other recording materials, such as recording materials having the A4 size or the Letter size, that have the regular paper width. Immediately after the recording materials having the regular size have passed through the fixing apparatus 12, the unevenness in temperature of the fixing film 13 is less produced than that produced immediately after small-sized recording materials have passed through the fixing apparatus 12. Thus, if the recovery mode is executed immediately after the recording materials having the regular size have passed through the fixing apparatus 12, the temperature of the center portion of the fixing film 13 in the longitudinal direction X can be efficiently made higher than the temperature of the end portion of the fixing film 13.

### 7. Other Embodiments

In the above-described embodiment, the contact type in which thermistors are used as the temperature sensors 22 and 23 is used. However, the present disclosure is not limited to this. For example, a non-contact type in which thermopiles or the like are used as the temperature sensors 22 and 23 may be used. Since the non-contact type sensors provide a faster temperature detection response than the contact-type temperature sensors do, the temperature control of the fixing film 13 can be performed with higher accuracy.

In addition, in the above-described embodiment, the base layer 13a is made of PI (polyimide), and the protection layer 13c is made of PAI (polyamide-imide). In this case, since the Young's modulus decreases more in the protection layer 13c than in the base layer 13a in the temperature rise, the neutral axis of the recording-material non-passage area (i.e., the end portion) of the fixing film 13 is shifted from the heat generating layer 13b to the base layer 13a side by the temperature rise. However, the configuration of the base layer 13a and the protection layer 13c is not limited to the above-described embodiment. For example, in a case where the base layer 13a is made of PAI and the protection layer 13c is made of PI, the Young's modulus decreases more in the base layer 13a than in the protection layer 13c in the temperature rise. As a result, the neutral axis of the recording-material non-passage area (i.e., the end portion) of the fixing film 13 is shifted from the heat generating layer 13b to the protection layer 13c side by the temperature rise. Even in a case where the neutral axis shifts to the protection layer 13c side, if the fixing film 13 receives bending stress at a high temperature, the electrical resistance value of the heat generating layer 13b increases. Thus, the same effects as those of the present embodiment can be produced by executing the above-described recovery mode.

The present disclosure can reduce the image defect.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082532, filed May 16, 2025, which is hereby incorporated by reference herein in its entirety.

What is claimed is:

1. A fixing apparatus configured to fix a toner image borne on a recording material to the recording material, the fixing apparatus comprising:
a film having a tubular shape and extending in a longitudinal direction, the film including:
a heat generating layer;
an inner layer formed on an inner circumference side of the heat generating layer; and
an outer layer formed on an outer circumference side of the heat generating layer;
a magnetic member inserted in an internal space of the film and extending in the longitudinal direction;
a coil helically wound around the magnetic member along the longitudinal direction;
a power supply configured to generate an alternating magnetic field by supplying alternating current to the coil and to cause the heat generating layer to generate heat by induced current;
a control portion configured to control a frequency of the alternating current output from the power supply;
a nip forming member configured to slide on an inner surface of the film; and
a pressing member configured to abut against an outer surface of the film, disposed such that the film is nipped by the pressing member and the nip forming member, and configured to form a nip portion between the pressing member and the nip forming member,
wherein the control portion is configured to execute
(i) a first mode in which the film is rotated while conveying a recording material to the nip portion with the frequency set to a first frequency, and
(ii) a second mode in which the film is rotated without conveying the recording material to the nip portion with the frequency set to a second frequency lower than the first frequency.

2. The fixing apparatus according to claim 1, wherein the heat generating layer has temperature dependence of Young's modulus different from those of the inner layer and the outer layer.

3. The fixing apparatus according to claim 1, wherein the inner layer is made of a first resin material, and
wherein the outer layer is made of a second resin material different from the first resin material.

4. The fixing apparatus according to claim 3, wherein the heat generating layer is made of a metal material.

5. The fixing apparatus according to claim 1, wherein the nip forming member includes a sliding surface configured to slide on the inner surface of the film, and
wherein the sliding surface of the nip forming member includes a projection portion, and
in a case where the longitudinal direction is a first direction, a recording-material conveyance direction in the nip portion is a second direction, and a direction orthogonal to both of the first direction and the second direction is a third direction, the projection portion is configured to project toward a side of the pressing member in the third direction.

6. The fixing apparatus according to claim 5, wherein the projection portion is positioned on a downstream side in the second direction, with respect to a center position of the nip portion in the second direction.

7. The fixing apparatus according to claim 1, wherein in a case where the control portion has executed the second mode, an amount of heat generation of an end portion of the film in the longitudinal direction becomes smaller than an amount of heat generation of a center portion of the film in the longitudinal direction.

8. The fixing apparatus according to claim 7, wherein in a case where the control portion has executed the second mode, a temperature of the center portion of the film becomes higher than a target temperature used for heating the toner image borne on the recording material.

9. The fixing apparatus according to claim 7, wherein the control portion executes the first mode in a case where a recording material of a first size having a width in the longitudinal direction corresponding to a maximum width usable in the fixing apparatus is conveyed.

10. The fixing apparatus according to claim 7, wherein the control portion executes the second mode in a case where a recording material of a second size having a width in the longitudinal direction smaller than a maximum width usable in the fixing apparatus is conveyed, and where a temperature of the end portion of the film becomes a predetermined temperature.

11. The fixing apparatus according to claim 7, further comprising a temperature sensor configured to detect a temperature of the end portion of the film,
wherein the control portion is configured to execute the second mode in a case where the temperature sensor detects a predetermined temperature.

12. The fixing apparatus according to claim 1, wherein the fixing apparatus is configured to heat, at the nip portion, the toner image borne on the recording material by the film while nipping and conveying the recording material with the film and the pressing member.

13. An image forming apparatus comprising:
an image forming portion configured to form a toner image on a recording material; and
the fixing apparatus according to claim 1 and configured to fix the toner image to the recording material.
